(19) United States
(12) Patent Application Publication
(10) Pub. No.: US 2005/0011367 A1
(43) Pub. Date: Jan. 20, 2005

(54) Portion control serving utensils

(76) Inventor: Frederick W. Crow, Lebanon, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/891,781

(22) Filed: Jul. 15, 2004

Related U.S. Application Data
(60) Provisional application No. 60/488,162, filed on Jul. 18, 2003.

(51) Int. Cl. A23L 1/00

(52) U.S. Cl. 99/342

(57) ABSTRACT

A serving utensil device determines a characteristic of food contained on the device. The device includes a utensil portion for receiving food and a handle portion removably secured to the utensil portion that includes a measuring mechanism for determining a characteristic of food contained on the utensil portion. A series of interchangeable utensil portions can be used with the device. A display device is located on the handle portion for displaying a characteristic of food, such as the amount, volume, and/or temperature.

### CROSS-REFERENCE TO RELATED APPLICATIONS

This application is based on provisional patent application Ser. No. 60/488,162, filed Jul. 18, 2003, and priority and the benefit of Ser. No. 60/488,162 is claimed in the present application to the extent the subject matter of this application is found in that provisional application. The content of that application is incorporated herein by reference.

### FIELD OF THE INVENTION

The present invention generally relates to serving utensils and more specifically to a serving utensil device that determines a characteristic of food contained on the utensil.

### BACKGROUND OF THE INVENTION

Obesity and being overweight are currently recognized to be at almost epidemic proportions in the United States. This is a problem that is currently emerging and is the topic of much interest and discussion. People constantly underestimate their weight and underestimate the amount of food they eat.

Excess weight can increase the risk of or cause diabetes, cardiovascular diseases, high blood pressure, stroke, joint pain, arthritis, sleep apnea, and several types of cancers including, but not limited to, breast, colon, prostate and kidney. Excess weight and inactivity is estimated to account for over 300,000 premature deaths each year.

Experts estimate that the percentage of overweight adults is as high as 60 to 65% in the United States alone. The problem doesn't rest only with adults. Reports indicate that since 1980, the number of overweight children has tripled, and that up to 25% of U.S. children are obese. It has been reported that unless people start eating less and exercising more, one in three children in the U.S. born in the year 2000 will become diabetic.

A common problem relating to the overweight and obesity dilemma is that one's eyes measure what is put on a plate, and that measurement of food is seldom, if ever, a “standard serving size”. A portion is the amount a user puts on his plate to eat. Oversize portions are a factor in the overweight and obesity dilemma. A “serving size” of a particular food is a standard amount set by the United States government, either by the U.S. Department of Agriculture with its Food Guide Pyramid or by The Food and Drug Administration's Nutritional Facts Label. In 1990, the Nutrition Labeling and Education Act of 1990 (NLEA Public Law 101-535) established the Nutrition Facts Panel that references standard serving sizes. These standard serving sizes represent the amounts customarily consumed and provide a standard measurement for nutritional values. Serving sizes for particular foods can be found on the Nutrition Facts Panel (label), on websites, recipes and food packages. Nutritional content, including the number of calories and the amount of fat, is given in terms of serving size. Proper and accurate serving size measurement is necessary to permit the consumer to monitor his or her food intake, and consequently, the intake of sugar, fat, sodium, and cholesterol, for example. Accurate serving size measurement encourages portion control and thus, weight management.

### SUMMARY OF THE INVENTION

It is therefore an object of the present invention to provide a system including a series of interchangeable serving utensils that can be operably and removably connected to a handle that accurately determines characteristics of food contained on the serving utensil, including measuring the amount of the food for example.

One aspect of the present invention concerns an apparatus comprising a utensil portion configured to receive a quantity of matter, and a handle portion, removably attached to the utensil portion, incorporating measuring means for determining a characteristic of matter received on the utensil portion. The device further includes a display device located on the handle portion to display an indication of the determined characteristic.

Another aspect of the present invention concerns a food serving apparatus comprising a utensil portion configured to receive a quantity of food, and a handle portion, removably attached to the utensil portion, incorporating a measuring device including electronics for determining a characteristic of food received on the utensil portion. The device further includes a display device located on the handle portion to display an indication of the characteristic of the food. Additionally, the device can include a decorative jacket over the handle portion.

Another aspect concerns a method of connecting a utensil to a handle, placing a quantity of food on the utensil, determining a characteristic of food contained on the utensil, and displaying an indication of the characteristic of food on a display device located on the handle. Further, the method can include weighing the amount of food contained on the utensil. A user of the device can determine if the amount of food is below, at, or above the suggested serving size of that particular food. The method can further include alerting the user of the device via an indicating mechanism that a pre-selected amount of food has been obtained on the utensil.

Another aspect concerns a method of controlling the portion size of food, comprising placing food on a serving utensil device which comprises a utensil portion removably secured to a handle portion, determining the portion size of the food, and displaying the portion size of the food on a display device located on the handle portion.

### BRIEF DESCRIPTION OF THE DRAWINGS

FIG. 1 is a top plan view of a serving utensil device according to one embodiment of the present invention.

FIG. 2 illustrates various serving utensils that may be used with the serving utensil device of FIG. 1.

FIG. 3 illustrates various handle covers that may be used with the serving utensil device of FIG. 1.

FIG. 4 is a top plan view of the handle mechanism of the serving utensil device of FIG. 1.

FIG. 5 is a schematic view illustrating the system utilized with the serving utensil device of FIG. 1.

FIG. 6 illustrates the control buttons of the serving utensil device of FIG. 1.

### DESCRIPTION OF PREFERRED EMBODIMENTS

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The present invention generally concerns a serving utensil device. The device generally includes a utensil and a removable handle with a display screen. Further, the device includes a measuring mechanism to determine a characteristic of food contained on the utensil, such as the amount of food, the volume of food, and/or the temperature of food. In one embodiment, the preparer of food or user of the device sets the desired portion amount, which can be the standard serving size, via controls on the handle portion, which is then displayed on the screen. The serving utensil has weighing capabilities; therefore, once the desired portion is reached, an indicating mechanism is activated notifying the user of the device that such desired portion has been reached. In another embodiment, the device weighs the amount of the portion of food contained on the utensil and displays the amount on the display screen. The user can then maintain, add to, or remove from the portion amount as desired, continually reading the amount on the display screen.

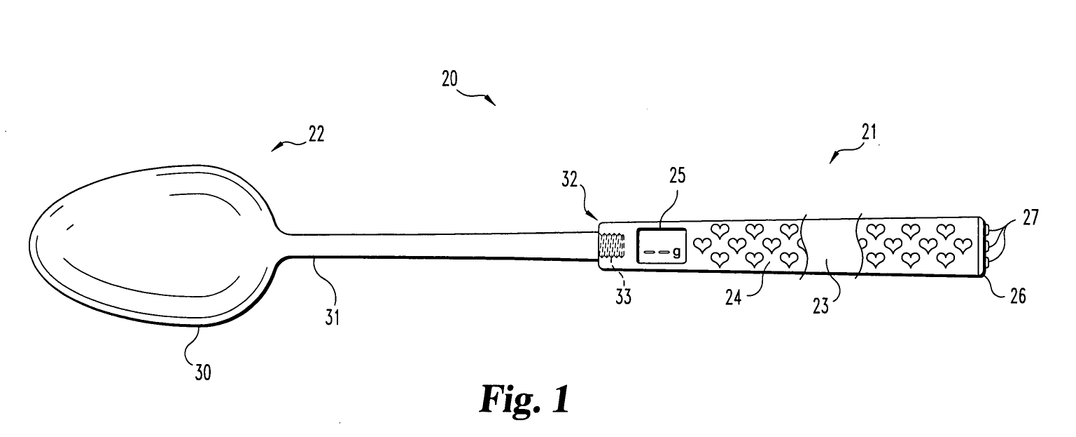

Referring to FIG. 1, a serving utensil device 20 according to one embodiment is shown. The device 20 generally includes a handle portion 21 for holding the device 20 and for determining and displaying a characteristic of food, operably and removably connected to a utensil portion 22 for obtaining, transferring, and serving food. The handle portion 21 generally includes a body 23, a cover 24, an operator display device 25, an end cap 26, and input control buttons 27. The utensil portion 22 generally includes a utensil head 30 and a utensil stem 31. The handle portion 22 further includes a handle screw member 33 within the body 23.

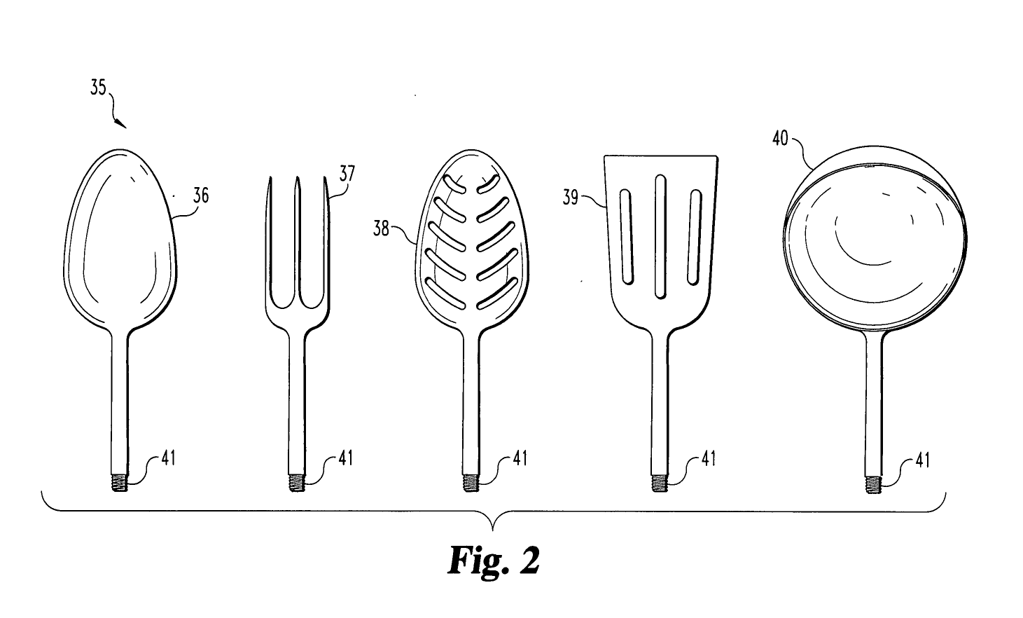

Referring to FIG. 2, there are various possibilities of utensils 35 that could be interchangeably utilized within the device 20. As examples, FIG. 2 illustrates a spoon 36, a fork 37, a slotted spoon 38, a spatula 39, and a ladle 40. However, it is contemplated that the device 20 can be interchangeably utilized with various other utensils as would generally occur to one skilled in the art, such as an ice cream scoop (not shown). In one embodiment, the utensils 35 (and utensil portion 22) are made from a stainless steel material. The utensils 35 include utensil screw members 41 for connection with the handle portion 21. In another embodiment, the utensils 35 (and utensil portion 22) are made from a plastic material, often preferred for use with non-stick cookware.

The handle portion 21 and the utensil portion 22 are operably and removably connected together by any appropriate means as would generally occur to one skilled in the art. In the illustrated embodiment, the handle portion 21 and the utensil portion 22 are operably and removably connected through the use of screw connectors, enabling the user of the device 20 to screw the utensil portion 22 into the handle portion 21. In that particular embodiment, the utensil stem 31 includes a utensil screw member 41 (shown in FIG. 2) which mates with the handle screw member 33 on the inner surface of the body 23 of the handle portion 21 (shown in FIG. 1). The utensil stem 31 of the utensil portion 22 is screwed into the handle portion 21 at a connection point 32. In other embodiments, the handle portion 21 and the utensil portion 22 can be connected through the use of screws, nut and bolt combinations, clamps, guide pins, sliding, or connectors wherein friction maintains the connection. The handle portion 21 and the utensil portion 22 being operably and removably connected together allows for interchangeable use of various other serving utensils 35 with the handle portion 21.

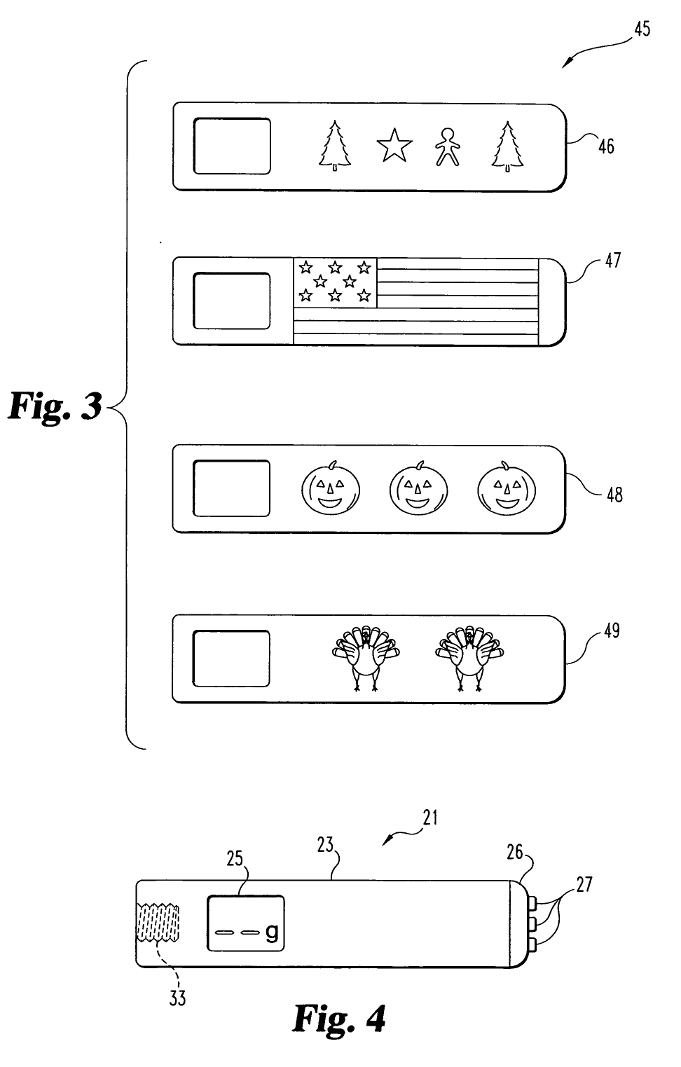

FIG. 3 illustrates examples of various decorative covers 45 that can be utilized with the device 20. The cover 24, shown in FIG. 1, includes a heart design that is typical of Valentine's Day decor and is one specific example of a decorative cover, such as those shown in FIG. 3. Further examples of the possible decorative covers are shown in FIG. 3, including a Christmas design cover 46, a United States flag design cover 47 for celebrating the Fourth of July or other similar holidays. Further, there is shown a Halloween design cover 48 and a Thanksgiving design cover 49. It is contemplated that other decorative design covers (not shown) could be used in conjunction with the device 20.

As illustrated in FIG. 3, the covers 45 contain openings 50 through which the operator display device 25 (shown in FIG. 1) can be seen. The decorative covers 45 (and cover 24) are removable from the device 20. The decorative covers 45 (and cover 24) can be configured to slide over the handle portion 21, placing the opening 50 over the operator display device 25. In another embodiment, the decorative covers 45 (and cover 24) include a zipper mechanism to allow for ease of placement on and removability from the handle portion 21. The decorative covers 45 (and cover 24) are formed from a heat resistant, non-flammable, and washable material, such as a woven fabric or similar type of material. For example, the decorative covers 45 (and cover 24) could be formed from cotton, nylon, or polyester materials. In one embodiment, the decorative covers 45 are treated before use, such as by ultraviolet light or chemically, to inhibit cross contamination of germs, bacteria, and viruses, from multiple users of the serving utensil device 20.

Referring to FIG. 4, there is shown the handle portion 21 without a cover. As illustrated, the operator display device 25 is located directly on the body 23. The operator display device 25 may be of a conventional design, such as a liquid crystal display (LCD), plasma, light emitting diode (LED), or such other type as would occur to those skilled in the art. Additionally, the end cap 26 of the handle portion 21 is operably and removably connected to the body 23, with input control buttons 27 operably connected to the end cap 26. In one embodiment, the device 20 is battery operated. End cap 26 is removed and batteries are placed in the body 23 for powering the device 20. However, it should be contemplated that the device 20 can be operated by any appropriate power source as would generally occur to one skilled in the art.

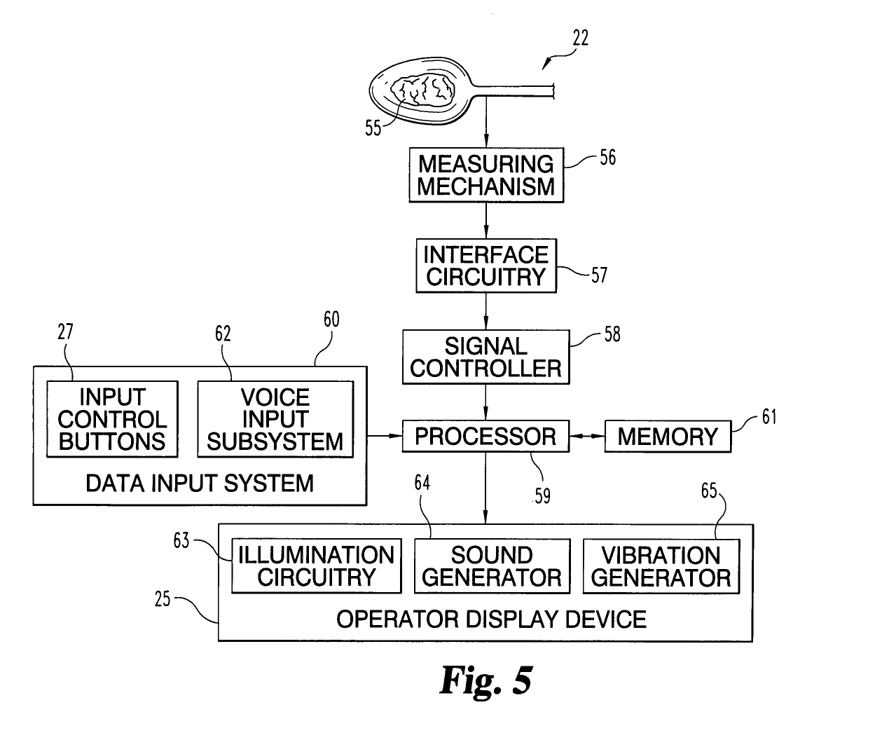

Referring to FIG. 5, as illustrated the device 20 incorporates various systems and circuitry elements that perform the functions associated herein, such as, but not limited to, a measuring mechanism 56, interface circuitry 57, a signal controller 58, a processor 59, a data input system 60, a memory system 61, and the operator display device 25. Interface circuitry 57, which can be of an analog type, is responsive to control signals from the measuring mechanism 56 operably connected to the utensil portion 22, containing a quantity of food 55, to provide corresponding analog stimulus signals via the appropriate circuitry. In one embodiment, signal controller 58 includes logic systems to alert the user of the device 20 when a pre-selected portion size has been attained or to alert the user of the device 20 of the measurement of the portion size. It is contemplated that the pre-selected portion size can be the standard serving size of the food. The device 20 could further include one or more digital-to-analog converters (DAC) to facilitate operation of the device 20 in the manner to be described in greater detail hereinafter. Processor 59 is coupled to signal controller 58 to communicate therewith, to selectively provide output to the operator display device 25, and to selectively respond to input from the data input system 60. The operator display device 25 can include additional elements such as illumination circuitry 63 for lighting the operator display device 25 at night or in low-light conditions, a sound generator 64, and/or a vibration generator 65. The sound generator 64 and vibration generator 65 can be utilized as types of alarm circuitry to alert the user when a pre-selected portion size has been attained on the utensil portion 22. In one embodiment as shown in FIG. 1, the data input system 60 involves the use of input control buttons 27. Alternatively or additionally, one or more other input devices can be utilized, such as a voice input subsystem 62, for example. Memory system 61 can be associated with processor 59 or alternatively can be separate from or at least partially included in one or more of signal controller 58 and processor 59. Memory system 61 can be at least partially integrated with circuitry 57, signal controller 58, and/or processor 59.

The device 20 further includes an electronic power supply system. In a simplified embodiment (as described above), the device can be operated by batteries located within the body 23 of the handle portion 21. However, it should be appreciated that the device 20 can be operated by any appropriate power supply as would occur to one skilled in the art. The power supply used to operate the device 20 is operably coupled to the appropriate circuitries involved in the operation of the device 20.

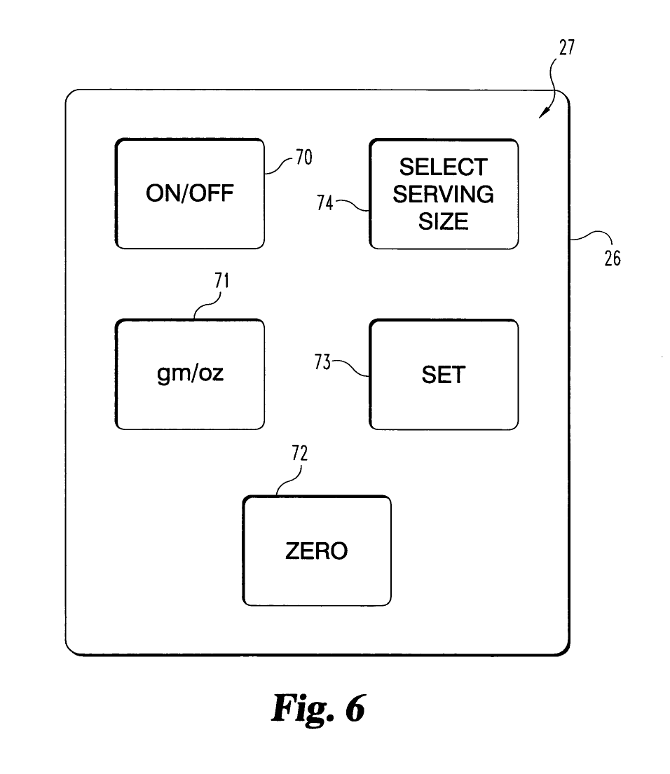

Referring to FIG. 6, the end cap 26 with the input control buttons 27 is shown. The input control buttons 27 are operably connected to various data input systems as would generally occur to those skilled in the art. In the embodiment illustrated in FIG. 6, there are five input control buttons 27, including an “on/off” button 55, a “grams/ounces” button 56, a “zero” button 57, a “set” button 58, and a “select serving size” button 59. However, it should be understood that various combinations of input control buttons 27 can be incorporated into the device 20 as would generally occur to those skilled in the art. Additionally, it should be appreciated that the input control buttons 27 can be located at different positions on the handle portion 21. The input control buttons 27 can be combined into one or more input control buttons with the inclusion of more complex electronic circuitry.

Generally referring to FIGS. 1-6, to operate the device 20 the user or operator begins by connecting the desired utensil portion 22 to the handle portion 21. In one embodiment, the user of the device 20 then determines the suggested serving size of the food to be consumed. The suggested serving size can be the portion size to be attained by the device 20 if so desired by the user. The suggested serving size can be ascertained from the nutritional label or the nutritional facts panel found in or on websites, recipes or packaging associated with the food to be consumed. Thereafter, the user inputs information to the handle portion 21 via the input control buttons 27. It should be appreciated that in one embodiment, a preparer of the food inputs the serving size into the device 20. As one example, the user turns on the device 20 by activating an on/off actuator such as button 55. The user selects the desired portion measuring units, e.g., grams or ounces, by activating button 56 until the correct unit of measurement is displayed in the operator display device 25. The user can then “zero out” or calibrate the device by activating a zero button such as button 57. Activating button 57 or initiating a similar action will set the measurement to 0 grams or 0 ounces after attachment of the selected serving utensil 22. Thus, the weight measurement of the selected serving utensil 22 will not be included and only the food obtained thereon will be weighed or measured.

The user of the device 20 acquires a food serving with the use of the utensil portion 22. In one embodiment, the device 20 operates so that the measurement of the portion size of the food on the utensil 22 is shown on the operator display device 25. Thus, the user of the device 20 places food onto the utensil portion 22 until the desired portion size is reached, which may, for example, be the suggested serving size of the particular food item. In another embodiment, before acquiring any food on the utensil portion 22, the user pre-selects the desired portion amount by activating the select serving size button 58. The button 58 can be configured so that each press of button 58 increases the measurement by a fixed amount, e.g., by 1 gram or 1 ounce. Once the desired portion size is shown in the operator display device 25, the user presses the set button 59. Thereafter, when the user of the device 20 acquires the pre-selected measured portion size onto the utensil portion 22, the device 20 alerts the user by a sound that the pre-selected portion size has been reached. In another embodiment, the device 20 alerts the user by a light. In even another embodiment, the device 20 alerts the user by a vibration. A vibration or a similar type of indicating mechanism aids in maintaining privacy for the user of the device 20. The device 20 can be configured so that the indicating mechanism is activated for a short time period or continues until the portion size on the utensil portion 22 reaches a level below the pre-selected portion size. However, it should be appreciated that the device 20 can be configured and designed in other ways and/or include different indicating mechanisms to alert the user that a pre-selected portion size has been attained. To operate the device 20 further with a different user or a different food item, the user presses the zero button 57 to again “zero out” the device 20. Continued and consistent use of the device 20 may assist the user to better visualize the appropriate portion sizes of various food items at times when the device 20 is not available for use. This trains the user to visually learn when a portion equals a standard serving size of a particular food. This also assists the user to consume only one serving size, as the hunger urge is less strong after having eaten one serving size and the user is less likely to return for second and third portions.

The device 20 can weigh or measure the portion size of the food contained on the utensil portion 22 by any appropriate means as would occur to one generally skilled in the art. In one embodiment, the device 20 includes weighing sensors at or near the connection point 32 and disposed within the body 23. The weighing sensors are operably connected to the circuitry of the device 20 and are in communication with the operator display device 25. In another embodiment, a strain gauge or similar mechanism may be located within the body 23 of the handle portion 21 to measure the amount of food that is contained on the utensil portion 22. This embodiment preferably includes an analog-digital converter to convert the strain gauge output to a signal recognizable by the circuitry used by the device 20 in order to display the resulting measurement on the operator display device 25. In another embodiment, the device 20 incorporates an electronic or digital scale to weigh the food contained on the utensil portion 22. However, it should be appreciated that the device 20 may incorporate any appropriate type of weighing or measuring mechanism as would generally occur to one skilled in the art.

In another embodiment, the device 20 determines the volume of food contained on the utensil portion 22. The device 20 can include appropriate electronic circuitry and other elements necessary to determine the volume of food. Additionally, the operator control buttons 27 can include a button (not shown) allowing the user to select units of cups or teaspoons, for example. In one embodiment, the device 20 can incorporate sensors on the utensil portion 22 that determine the quantity of food contained thereon and electronic circuitry which utilizes the geometric configuration of the serving utensil portion 22 and displays the volume of food on the operator display device 25. However, it should be appreciated that the device 20 can incorporate any appropriate volume measuring system as would generally occur to one skilled in the art. In even another embodiment, the device 20 determines the temperature of food contained on the utensil portion 22. The operator control buttons 27 can include a button (not shown) allowing the user to select units of degrees Celsius or degrees Fahrenheit, for example. The device 20 can include appropriate electronic circuitry and other elements necessary to determine the temperature of food. As an example, the device 20 can include sensors located on the utensil portion 22 for measuring the temperature of the food and electronic circuitry to display the temperature of food on the operator display device 25. However, it should be appreciated that the device 20 can incorporate any appropriate temperature measuring device as would generally occur to one skilled in the art.

The device 20 is cleaned after use by removing the serving utensil portion 22 from the handle portion 21. The serving utensil portion 22 is cleaned in a manner typical for other similar kitchen utensils. The handle portion 21 is cleaned in a manner consistent with devices containing sensitive electronic circuitry.

Further, any theory, mechanism of operation, proof, or finding stated herein is meant to further enhance understanding of the present invention, and is not intended to limit the present invention in any way to such theory, mechanism of operation, proof, or finding. While the invention has been illustrated and described in detail in the drawings and foregoing description, the same is to be considered as illustrative and not restrictive in character, it being understood that only selected embodiments have been shown and described and that all equivalents, changes, and modifications that come within the spirit of the inventions as defined herein or by the following claims are desired to be protected.

1. An apparatus, comprising:
a utensil portion configured to receive a quantity of matter;
a handle portion, removably attached to said utensil portion, incorporating measuring means for determining a characteristic of matter received on said utensil portion; and
a display device disposed on said handle portion for displaying an indication of said determined characteristic.

2. A food serving apparatus, comprising:
a utensil portion configured to receive a quantity of food;
a handle portion, removably attached to said utensil portion, incorporating a measuring device including electronics for determining a characteristic of food received on said utensil portion; and
a display device disposed on said handle portion for displaying an indication of said determined characteristic.

3. A utensil as claimed in claim 2, wherein:
said utensil portion being selected from the group consisting of a spoon, a fork, a spatula, an ice cream scoop, and a spoon containing slotted openings.

4. A utensil as claimed in claim 2, further comprising:
a decorative cover removably covering said handle portion.

5. A utensil as claimed in claim 4, wherein:
said decorative cover incorporates an opening of substantially similar size and shape as said display device, said opening configured to be located over said display device.

6. A utensil as claimed in claim 2, further comprising:
electronic circuitry to operate said display device disposed on said handle portion.

7. A utensil as claimed in claim 2, wherein:
said characteristic being selected from the group consisting of an amount of food, a volume of food, and a temperature of food.

8. A utensil as claimed in claim 7, wherein:
said measuring device includes a scale disposed in said handle portion to determine the amount of food received on said utensil portion.

9. A utensil as claimed in claim 7, wherein:
said measuring device includes sensors disposed in said handle portion to determine the amount of food received on said utensil portion.

10. A utensil as claimed in claim 9, wherein:
said sensors weigh food received on said utensil portion to determine the weight of food.

11. A utensil as claimed in claim 10, wherein:
said display device displays the weight of food received on said utensil portion.

12. A utensil as claimed in claim 11, wherein:
said display device displays the weight of food received on said utensil portion in units of grams.

13. A utensil as claimed in claim 11, wherein:
said display device displays the weight of food received on said utensil portion in units of ounces.

14. A utensil as claimed in claim 2, wherein:
said handle portion contains a first member;
said utensil portion contains a second member; wherein
said first member and second member mechanically cooperate to connect said handle portion and said utensil portion.

15. A utensil as claimed in claim 2, further comprising:
a data input system disposed on said handle portion.

16. A utensil as claimed in claim 15, wherein:
said data input system is a voice input system.

17. A utensil as claimed in claim 15, wherein:
said data input system is a set of operator control buttons.

18. A utensil as claimed in claim 17, further comprising:
an end cap, removably connected to said handle portion, to house said set of operator control buttons.

19. A utensil as claimed in claim 2, further comprising:
electronic circuitry, disposed within said handle portion, programmed to provide an indication when a pre-selected characteristic of food received on said utensil portion is identified.

20. A utensil as claimed in claim 19, wherein:
said pre-selected characteristic of food is the standard serving size.

21. A utensil as claimed in claim 19, wherein:
said indication being selected from the group consisting of a vibration, a sound, and a light.

22. A method, comprising:
connecting a utensil to a handle;
placing a quantity of food on said utensil;
determining a characteristic of food contained on said utensil; and
displaying an indication of said characteristic of food contained on said utensil on a display device disposed on said handle.

23. The method claimed in claim 22, further comprising:
placing a decorative cover over said handle portion, said decorative cover including an opening for viewing said display device.

24. The method claimed in claim 22, further comprising:
providing a variety of utensil shapes for connecting to said handle portion.

25. The method claimed in claim 22, further comprising:
determining the amount of food using a measuring device; and
programming said display device to illuminate a designation representing the amount of food.

26. The method claimed in claim 22, further comprising:
determining the volume of food using a measuring device; and
programming said display device to illuminate a designation representing the volume of food.

27. The method claimed in claim 22, further comprising:
determining the temperature of food using a measuring device; and
programming said display device to illuminate a designation representing the temperature of food.

28. The method claimed in claim 25, further comprising:
identifying a pre-selected amount of food via the use of said display device and emitting energy from said handle portion when said pre-selected amount has been reached, said energy being selected from the group consisting of vibration, sound, and light.

29. The method claimed in claim 25, further comprising:
viewing the amount of food displayed in said display device to determine when a suggested serving size amount has been reached.

30. The method claimed in claim 25, further comprising:
programming said display device to illuminate a designation representing units being selected from the group consisting of grams and ounces.

31. The method claimed in claim 26, further comprising:
programming said display device to illuminate a designation representing units being selected from the group consisting of cups and teaspoons.

32. The method claimed in claim 27, further comprising:
programming said display device to illuminate a designation representing units being selected from the group consisting of degrees Celsius and degrees Fahrenheit.

33. A method for controlling the portion size of food, comprising:
placing food on a serving device comprising a utensil portion removably secured to a handle portion;
determining the portion size of said food contained on said utensil portion; and
displaying the portion size of said food on a display device disposed on said handle portion.

34. The method of claim 33, further comprising:
weighing said food with a measuring device including electronics to electronically weigh said food.

35. A system, comprising:
a series of two or more interchangeable utensil portions configured to receive a quantity of matter;
a handle portion, removably attached to one of said utensil portions, incorporating a measuring mechanism for determining a characteristic of matter received on said utensil portion; and
a display device disposed on said handle portion for displaying an indication of said determined characteristic.
